(19) United States
(12) Patent Application Publication
(10) Pub. No.: US 2026/0125572 A1
(43) Pub. Date: May 7, 2026

(54) COATING COMPOSITIONS, COATED BUILDING PANELS, AND METHODS FOR MAKING THE SAME

(71) Applicant: ARMSTRONG WORLD INDUSTRIES, INC., Lancaster, PA (US)

(72) Inventors: Ying CHANG, Lincoln University, PA (US); Timothy ASTON, Columbia, PA (US); Brian BAKEY, Lancaster, PA (US); Diane ARTMAN, Lancaster, PA (US); Michael PELFREY, Lancaster, PA (US); Anthony PETRICCA, Lancaster, PA (US)

(73) Assignee: ARMSTRONG WORLD INDUSTRIES, INC., Lancaster, PA (US)

(21) Appl. No.: 19/374,423

(22) Filed: Oct. 30, 2025

Related U.S. Application Data
(60) Provisional application No. 63/715,587, filed on Nov. 3, 2024.

(51) Int. Cl. C09D 133/04; C09D 5/14; C09D 5/18; C09D 7/65; E04B 9/04

(52) U.S. Cl. CPC C09D 133/04; C09D 5/14; C09D 5/18; C09D 7/65; E04B 9/04

(57) ABSTRACT

A coating composition includes a crosslinking binder composition comprising crosslinking functional groups or crosslinker, a pigment composition, a flame retardant, a filler composition, and a biocide. A building panel includes a substrate having a first major surface opposite a second major surface and a side surface extending there-between, and a coating composition over at least one of the first major surface, the second major surface, and the side surface, the coating composition including a crosslinkable binder composition including a crosslinker and a binding agent, a pigment composition, a flame retardant, and a filler composition.

### CROSS-REFERENCE TO RELATED APPLICATION

This application claims priority to U.S. Provisional Patent Application No. 63/715,587, filed on Nov. 3, 2024, the entirety of which is incorporated by reference herein.

### FIELD OF THE DISCLOSURE

The present disclosure relates to coating compositions for coating panels, such as ceiling and wall panels, and more particularly to coating compositions for impact-resistance.

### BACKGROUND

Building materials, such as planks and panels of ceiling and wall systems, are commonly coated with coating compositions, such as paints, for aesthetic purposes. These building materials are susceptible to damage on the surfaces during transport, thus creating wasted material and increasing costs.

Accordingly, those skilled in the art continue research and development in the field of coating compositions to increase impact resistance and reduce defects.

### SUMMARY

This summary is intended merely to introduce a simplified summary of some aspects of one or more implementations of the present disclosure. Further areas of applicability of the present disclosure will become apparent from the detailed description provided hereinafter. This summary is not an extensive overview, nor is it intended to identify key or critical elements of the present teachings, nor to delineate the scope of the disclosure. Rather, its purpose is merely to present one or more concepts in simplified form as a prelude to the detailed description below.

Applicants have discovered coating compositions useful for application on panels, such as wall or ceiling panels.

A coating composition includes a crosslinkable binder composition including a crosslinker and a binding agent, a pigment composition, a flame retardant, a filler composition, and a biocide.

In one example, the binder composition includes an acrylic copolymer. In one example, the binder composition includes vinyl-acrylic latex. In one example, the binder composition includes a pH ranging from about 4.5 to about 8.5. In one example, the binder composition has a glass transition temperature below ambient temperature. In one example, the binder composition has a glass transition temperature below 10° C. In one example, the binder composition includes a glass transition temperature below 1° C. In one example, the binder composition includes a viscosity less than 500 cps.

In one example, the coating composition has a solids content ranging from about 60 wt. % to about 75 wt. %. In one example, the binder composition includes a blend of a first binder and a second binder. In one example, the first binder has a first glass transition temperature and the second binder has a second glass transition temperature that is different than the first glass transition temperature.

In one example, the coating composition includes a filler to binder ratio ranging from about 0.1 to about 20. In one example, the coating composition includes a filler to binder ratio ranging from about 1:1 to about 4:1. In one example, the coating composition includes a filler to binder ratio of about 2:1.

In one example, the pigment composition includes titanium dioxide.

In one example, the coating composition includes a humectant. In one example, the humectant includes a hydrophobic polymer emulsion. In one example, the humectant includes a pH ranging from about 7 to about 9.

In one example, the coating composition includes clay. In one example, the coating composition includes a calcined extender. In one example, the coating composition includes a dispersant. In one example, the coating composition includes a wetting agent. In one example, the coating composition includes a defoamer. In one example, the biocide includes one or more antimicrobial agents.

A building panel includes a substrate having a first major surface opposite a second major surface and a side surface extending there-between, and a coating composition over the side surface, the coating composition including a crosslinkable binder composition including a crosslinker and a binding agent, a pigment composition, a flame retardant, and a filler composition.

In one example, the coating composition is present in an amount ranging from about 30 g/sqft to about 200 g/sqft. In one example, the coating composition optionally includes a humectant. In one example, the coating composition further includes a biocide. In one example, the binder composition includes an acrylic copolymer. In one example, the binder composition includes vinyl-acrylic latex. In one example, the binder composition includes a pH ranging from about 4.5 to about 8.5. In one example, the binder composition has a glass transition temperature below ambient temperature. In one example, the binder composition has a glass transition temperature below 10° C. In one example, the binder composition includes a glass transition temperature below 1° C.

In one example, the building panel includes a scrim over the first major surface. In one example, the scrim is a fiberglass scrim. In one example, the building panel includes a second coating composition over the first major surface, wherein the second coating composition includes a binder composition that is different than the coating composition over the side surface. In one example, the second coating composition includes a binder composition that is not crosslinkable.

A surface covering system includes a plurality of building panels configured to be positioned adjacent each other, each building panel of the plurality of building panels including a substrate having a first major surface opposite a second major surface and a side surface extending there-between, and a coating composition over at least one of the first major surface, second major surface, and the side surface. The coating composition includes a binder that can self-crosslink or crosslink with additional crosslinking agents, a pigment composition, a flame retardant, and a filler composition.

In one example, the coating composition is present in an amount ranging from about 30 g/ft to about 200 g/ft. In one example, the coating composition optionally includes a humectant. In one example, the coating composition further includes a biocide. In one example, the binder composition includes an acrylic copolymer. In one example, the binder composition includes vinyl-acrylic latex. In one example, the binder composition includes a pH ranging from about 4.5 to about 8.5. In one example, the binder composition has a glass transition temperature below ambient temperature. In one example, the binder composition includes a glass transition temperature below 1° C. In one example, the plurality of building panels defines a ceiling. In one example, the plurality of building panels defines a wall.

A method for manufacturing a building panel includes providing a substrate having a first major surface opposite a second major surface and a side surface extending there-between, applying a coating composition over at least one of the first major surface, second major surface, and the side surface, the coating composition including a crosslinkable binder composition including a crosslinker and a binding agent, a pigment composition, a flame retardant, and a filler composition.

In one example, the method includes applying a second coating composition over the first major surface, wherein the second coating composition includes a binder composition that is different than the coating composition over the side surface. In one example, the second coating composition includes a binder composition that is not crosslinkable.

### DESCRIPTION OF THE DRAWINGS

The detailed description of the disclosure will be better understood when read in conjunction with the appended drawings. It should be understood, however, that the disclosure is not limited to the precise arrangements and instrumentalities of the examples shown in the drawings.

FIG. 1 is a top perspective view of a coated building panel according to an example of the present disclosure;

FIG. 2 is a cross-sectional view of the coated building panel according to an example of the present disclosure, the cross-sectional view being along the II line set forth in FIG. 1;

FIG. 3 is a cross-sectional view of a coated building panel according to an example of the present disclosure; and

FIG. 4 is a ceiling system comprising the coated building panel of the present disclosure.

### DETAILED DESCRIPTION

For illustrative purposes, the principles of the present disclosure are described by referencing various examples thereof. Although certain examples of the disclosure are specifically described herein, one of ordinary skill in the art will readily recognize that the same principles are equally applicable to, and can be employed in other applications and methods. It is to be understood that the disclosure is not limited in its application to the details of any particular example shown. The terminology used herein is for the purpose of description and not to limit the disclosure, its application, or uses.

As used herein and in the appended claims, the singular forms “a”, “an”, and “the” include plural references unless the context dictates otherwise. The singular form of any class of the ingredients refers not only to one chemical species within that class, but also to a mixture of those chemical species. The terms “a” (or “an”), “one or more” and “at least one” may be used interchangeably herein. The terms “comprising”, “including”, “containing”, and “having” may be used interchangeably. The term “include” should be interpreted as “include, but are not limited to”. The term “including” should be interpreted as “including, but are not limited to”.

As used throughout, ranges are used as shorthand for describing each and every value that is within the range. Any value within the range can be selected as the terminus of the range.

Unless otherwise specified, all percentages and amounts expressed herein and elsewhere in the specification should be understood to refer to percentages by weight of the total composition. Unless otherwise specified, reference to a molecule, or to molecules, being present at a “wt. %” refers to the amount of that molecule, or molecules, present in the composition based on the total weight of the composition. Unless otherwise specified, reference to a molecule, or to molecules, being present “based on the dry weight of the composition” refers to that molecule, or molecules, being present in the composition based on the total weight of the composition in a dry state. The “dry state” refers to solvent being present in the composition at an amount less than 5.0 wt. %, less than about 3.0 wt. %, less than about 1.0 wt. %; preferably less than about 0.5 wt. %, and more preferably less than about 0.25 wt. % of the composition. For example, a composition in the dry state may refer to a composition having about 95% solids, about 98% solids, preferably about 99% solids, or more preferably about 100% solids. By contrast, unless otherwise specified, reference to a molecule, or to molecules, being present “based on the wet weight of the composition” refers to that molecule, or molecules, being present in the composition based on the total weight of the composition which includes at least 5 wt. % of solvent.

According to the present application, use of the term “about” in conjunction with a numeral value refers to a value that may be +/−5% of that numeral. As used herein, the term “substantially free” is intended to mean an amount less than about 5.0 wt. %, less than 3.0 wt. %, less than 1.0 wt. %; preferably less than about 0.5 wt. %, and more preferably less than about 0.25 wt. % of the composition.

Unless defined otherwise, all technical and scientific terms used herein have the same meanings as commonly understood by one of ordinary skill in the art to which this disclosure belongs. All patents, patent applications, publications, and other references cited or referred to herein are incorporated by reference in their entireties for all purposes. In the event of a conflict in a definition in the present disclosure and that of a cited reference, the present disclosure controls.

In the description of examples disclosed herein, any reference to direction or orientation is merely intended for convenience of description and is not intended in any way to limit the scope of the present disclosure. Relative terms such as “lower,” “upper,” “horizontal,” “vertical,”, “above,” “below,” “up,” “down,” “top” and “bottom” as well as derivatives thereof (e.g., “horizontally,” “downwardly,” “upwardly,” etc.) should be construed to refer to the orientation as then described or as shown in the drawing (if applicable) under discussion. These relative terms are for convenience of description only and, unless specified otherwise, do not require that the apparatus be constructed or operated in a particular orientation.

As used herein, terms such as “attached,” “affixed,” “connected,” “coupled,” “interconnected,” and the like refer to a relationship wherein structures are secured or attached to one another either directly or indirectly through intervening structures, as well as both movable or rigid attachments or relationships, unless expressly described otherwise. Accordingly, the disclosure is not limited to such examples illustrating certain combinations of features that may exist alone or in combination with other features.

The present disclosure relates to coating compositions, methods for making coating compositions, and panels coated with the disclosed coating compositions. The disclosure utilizes a coating composition designed for surfaces, such as edge surfaces, of building panels. The coating composition advantageously provides superior mechanical properties while maintaining desired acoustic and aesthetic properties.

The disclosed coating composition a crosslinkable binder composition. The crosslinkable binder composition may include a binder that can self-crosslink from the functional groups up to 5% by weight. In one example, the crosslinking functional groups include one or more of a hydroxy, carboxy, amine, glycidyl, or N-methylol. In another example, the binder composition comprises a crosslinker such as one or more isocyanates, carbodiimides or aziridines up to 5% by weight.

In one example, the binder composition includes an acrylic copolymer. In another example, the binder composition includes vinyl-acrylic latex. In one example, the binder composition is characterized by its pH. The binder composition may have a pH ranging from about 4 to about 7, from about 5.5 to about 6.5, or from about 5 to about 6.

In one or more examples, the binder composition may be characterized by its glass transition temperature. In one example, the binder has glass transition below ambient temp. In another example, the binder composition has a glass transition temperature below 10° C. In another example, the binder composition has a glass transition temperature below 1° C. in a further example, the binder composition has a glass transition temperature of about −1° C.

The binder composition may be further characterized by its viscosity. In one example, the binder composition has a viscosity less than 500 cps.

In one or more examples, the binder composition includes a blend of two or more binders. In one example, the first binder has a first glass transition temperature, and the second binder has a second glass transition temperature that is different than the first glass transition temperature.

In one or more examples, the disclosed coating composition includes a pigment composition. The pigment composition may be a blend including a mix of pigments and fillers, such as titanium dioxide extenders, designed to adequately cover panels, such as ceiling panels, while maintaining desired material properties, such as acoustical, mechanical, and optical. The disclosed coating composition allows for optimal impact resistance.

In one or more examples, the coating composition includes calcium carbonate. In one example, the calcium carbonate is present in an amount from about 20 wt. % to about 60 wt. %, based on the dry weight of the composition. In another example, the calcium carbonate is present in an amount from about 25 wt. % to about 35 wt. %, based on the dry weight of the composition. In yet another example, the calcium carbonate is present in an amount from about 27.0 wt. % to about 32.5 wt. %, based on the dry weight of the composition.

In one or more examples, the coating composition includes titanium dioxide. The titanium dioxide may be present at any concentration needed to achieve the desired pigment-to-binder ratio as described herein. In one example, the titanium dioxide is present at a concentration from about 0.1 wt. % to about 5 wt. %, based upon the dry weight of the composition. In another example, the titanium dioxide is present at a concentration from about 0.5 wt. % to about 4 wt. %, based upon the dry weight of the composition. In yet another example, the titanium dioxide is present at a concentration or from about 1 wt. % to about 3 wt. %, based upon the dry weight of the composition. In a preferred example, the titanium dioxide is present at a concentration from about 1 wt. % to about 2 wt. %, based upon the dry weight of the composition.

In one or more examples, the coating composition includes calcined diatomaceous earth. The calcined diatomaceous earth may be present at any concentration needed to achieve the desired pigment-to-binder ratio as described herein. In one example, the calcined diatomaceous earth is present in an amount from about 1 wt. % to about 20 wt. %, based on the dry weight of the composition. In another example, the calcined diatomaceous earth is present in an amount from about 1 wt. % to about 10 wt. %, based on the dry weight of the composition. In yet another example, the calcined diatomaceous earth is present in an amount from about 1.5 wt. % to about 7.5 wt. %, based on the dry weight of the composition. In a further example, the calcined diatomaceous earth is present in an amount from about 1 wt. % to about 2 wt. %, about 1.1 wt. %, about 1.2 wt. %, about 1.3 wt. %, about 1.4 wt. %, about 1.5 wt. %, about 1.6 wt. %, about 1.7 wt. %, about 1.8 wt. %, or about 1.9 wt. %, based on the total dry weight of the composition.

In one or more examples, the coating composition includes a flame retardant. The flame retardant may include aluminum, such as aluminum hydroxide or aluminum trihydrate. The aluminum hydroxide may be present at any concentration needed to achieve the desired pigment-to-binder ratio as described herein. In one example, the aluminum hydroxide is present in an amount from about 3 wt. % to about 20 wt. %, based on the dry weight of the composition. In another example, the aluminum hydroxide is present in an amount from about 5 wt. % to about 18 wt. %, based on the dry weight of the composition. In yet another example, the aluminum hydroxide is present in an amount from about 10 wt. % to about 15 wt. %, based on the dry weight of the composition.

In one or more examples, the coating composition optionally includes a humectant. The humectant may include a hydrophobic polymer emulsion. In one example, the hydrophobic polymer emulsion is present in an amount from about 0.1 wt. % to about 10 wt. %, based on the dry weight of the composition. In another example, the hydrophobic polymer emulsion is present in an amount from about 0.3 wt. % to about 5.0 wt. %, based on the dry weight of the composition. In yet another example, the hydrophobic polymer emulsion is present in an amount from about 0.4 wt. % to about 1 wt. %, based on the dry weight of the composition. In a further example, the hydrophobic polymer emulsion is present in an amount from about 0.4 wt. % to about 0.6 wt. %, based on the dry weight of the composition.

The coating composition optionally includes a wetting and dispersing additive. In one example, the wetting and dispersing additive includes an anionic copolymer. The wetting and dispersing additive may have an acid value of about 2 mg KOH/g. In one example, the wetting and dispersing additive is present in an amount from about 0.1 wt. % to about 5 wt. %, based on the dry weight of the composition. In another example, the wetting and dispersing additive is present in an amount from about 0.1 wt. % to about 2 wt. %, based on the dry weight of the composition. In yet another example, the wetting and dispersing additive is present in an amount from about 0.1 wt. % to about 0.5 wt. %, based on the dry weight of the composition.

The coating composition optionally includes clay, such as a hectorite clay, laponite clay, or bentonite clay. In one example, the clay is present in an amount from about 0.01 wt. % to about 5 wt. %, based on the dry weight of the composition. In another example, the clay is present in an amount from about 0.03 wt. % to about 2 wt. %, based on the dry weight of the composition. In yet another example, the clay is present in an amount from about 0.03 wt. % to about 0.5 wt. %, based on the dry weight of the composition.

The coating composition optionally includes a defoamer. The defoamer may include wax and/or mineral oil. In one example, the defoamer is present in an amount from about 0.01 wt. % to about 2 wt. %, based on the dry weight of the composition. In another example, the defoamer is present in an amount from about 0.01 wt. % to about 1 wt. %, based on the dry weight of the composition. In yet another example, the defoamer is present in an amount from about 0.01 wt. % to about 0.5 wt. %, based on the dry weight of the composition.

The coating composition optionally includes one or more biocides, such as an antimicrobial or antifungal additive. In one example, the one or more biocides are present in an amount from about 0.01 wt. % to about 1 wt. %, based on the dry weight of the composition. In another example, the one or more biocides are present in an amount from about 0.05 wt. % to about 0.5 wt. %, based on the dry weight of the composition. In yet another example, the one or more biocides are present in an amount from about 0.05 wt. % to about 0.4 wt. %, based on the dry weight of the composition.

The coating composition optionally includes a precipitated synthetic silicate additive. In one example, the precipitated synthetic silicate is present in an amount from 0.1 wt. % to about 5 wt. %, based on the dry weight of the composition. In another example, the precipitated synthetic silicate is present in an amount from about 0.5 wt. % to about 3.5 wt. %, based on the dry weight of the composition. In yet another example, the precipitated synthetic silicate is present in an amount from about 0.5 wt. % to about 2 wt. % %, based on the dry weight of the composition. In a further example, the precipitated synthetic silicate is present in an amount from about 0.9 wt. % to about 1 wt. % %, based on the dry weight of the composition.

The coating composition optionally includes a calcined extender additive. In one example, the calcined extender is present in an amount from about 1 wt. % to about 6 wt. %, based on the dry weight of the composition. In another example, the calcined extender is present in an amount from about 2 wt. % to about 5 wt. %, based on the dry weight of the composition. In yet another example, the calcined extender is present in an amount from about 3 wt. % to about 5 wt. %, based on the dry weight of the composition. In a further example, the calcined extender is present in an amount from about 4.25 wt. % to about 4.75 wt. %, based on the dry weight of the composition.

In one or more examples, the coating composition is characterized by a filler to binder ratio. The composition may have a filler to binder ratio ranging from about 0.1 to about 20. In another example, the composition has a filler to binder ratio ranging from about 1:1 to about 10:1. in another example, the composition has a filler to binder ratio ranging from about 1:1 to about 5:1. In a further example, the composition has a filler to binder ratio of about 1:1, about 2:1, about 3:1, or about 4:1.

The coating composition may be further characterized by its solids content. In one example, the coating composition has a solids content ranging from about 60 wt. % to about 75 wt. %.

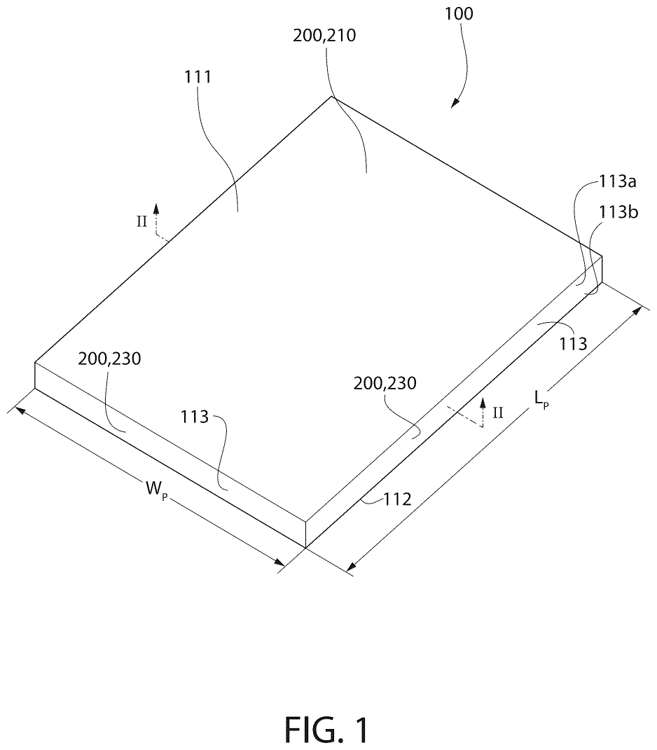

Referring to FIGS. 1 through 4, also disclosed are building panels 100, such as ceiling or wall panels. In one example, the building panels 100 are acoustical panels having appropriate acoustical characteristics for the specified application. Some non-limiting examples of panel materials that may be used include, without limitation, mineral fiber board, fiberglass, metals, polymers, wood, composites, combinations thereof, or other. Examples of panels have a sufficiently high noise reduction coefficient (NRC) and ceiling attenuation class (CAC) rating to be characterized as an acoustical substrate in contrast to gypsum-based drywall having substantially lower NRCs (e.g. 0.05) characteristic of sound reflecting, not absorbing materials. NRC is a measure of sound energy absorption of a material. An NRC rating of 0 is a perfect sound reflection material. An NRC rating of 1 is a perfect sound absorption material. CAC is a measure for rating the performance of a ceiling material as a barrier to block airborne sound transmission through the material to/from the plenum above the ceiling. In one or more examples, the disclosed building panel 100 with the coating 200 yields an NRC rating of about 0.8.

An important characteristic for building materials is the burning performance. ASTM E84-20 provides methods to determine the relative burning behavior of the material. In particular, ASTM E84-20 provides methods for determining the Flame Spread Index (FSI) which characterizes how far flames generated on the test material spread. The FSI is measured from 0 (indicating no flames) to 200 (which indicates spreading flames). ASTM E84-20 also provides methods for determining the Smoke Developed Index (SDI) which states how much smoke is generated. SDI is measured on a scale of 0 to 450, which correlates to no smoke generated (value of 0) to thick, heavy smoke (value of 450). Obtained FSI and SDI values are then compiled and applied to a three-tiered class system: Class A, Class B, and Class C, with Class A rated materials producing minimal to no flames or smoke, while Class C materials producing the most flames or smoke. In order to qualify as an E84 Class A fire rating, a flame spread index (FSI) of 25 or less and smoke developed index (SDI) at 450 or less must be exhibited. In certain examples, the building panel has a flame spread index (FSI) of about 0 to about 10, as determined by ASTM E84-20. In certain examples, the building panel 100 has a flame spread index (FSI) of about 10 as determined by ASTM E84-20. In certain examples, the building panel has a flame spread index (FSI) of about 0 as determined by ASTM E84-20. In certain examples, the building panel 100 has a smoke developed index (SDI) of about 450, or less, as determined by ASTM E84-20. In certain examples, the building panel 100 has a smoke developed index (SDI) of about 350, or less, as determined by ASTM E84-20.

In one or more examples, the building panel 100 includes a substrate 120 having a first major surface 121 opposite a second major surface 122 and a side surface 123 extending there-between. The building panel 100 further includes a coating 230 having the coating composition disclosed herein over at least one of the first major surface 121, the second major surface 122, and the side surface 123. In another example, the coating composition is over the side surface 123. In yet a further example, the coating composition is over two or more of the first major surface 121, the second major surface 122, and the side surface 123. The coating composition includes a crosslinkable binder composition including a crosslinker and a binding agent, a pigment composition, a flame retardant, and a filler composition.

The coating composition of the coating 230 comprises a crosslinkable binder composition. The crosslinkable binder composition includes a binder that can self-crosslink from the functional groups up to 5% by weight. In one example, the crosslinking functional groups include one or more of a hydroxy, carboxy, amine, glycidyl, or N-methylol. In another example, the binder composition comprises a crosslinker such as one or more isocyanates, carbodiimides or aziridines up to 5% by weight.

In one example, the binder composition includes an acrylic copolymer. In another example, the binder composition includes vinyl-acrylic latex. In one example, the binder composition is characterized by its pH. The binder composition may have a pH ranging from about 4 to about 7, from about 5.5 to about 6.5, or from about 5 to about 6.

In one or more examples, the binder composition may be characterized by its glass transition temperature. In one example, the binder has glass transition below ambient temp. In another example, the binder composition has a glass transition temperature below 10° C. In another example, the binder composition has a glass transition temperature below 1° C. in a further example, the binder composition has a glass transition temperature of about −1° C.

In one or more examples, the binder composition includes a blend of two or more binders. In one example, the first binder has a first glass transition temperature, and the second binder has a second glass transition temperature that is different than the first glass transition temperature.

In one or more examples, the disclosed coating composition of the coating 230 includes a pigment composition. The pigment composition may be a blend including a mix of pigments and fillers, such as titanium dioxide extenders, designed to adequately cover panels, such as ceiling panels, while maintaining desired material properties, such as acoustical, mechanical, and optical. The disclosed coating composition allows for optimal impact resistance.

In one or more examples, the coating composition of the coating 230 includes calcium carbonate. In one example, the calcium carbonate is present in an amount from about 20 wt. % to about 60 wt. %, based on the dry weight of the composition. In another example, the calcium carbonate is present in an amount from about 25 wt. % to about 35 wt. %, based on the dry weight of the composition. In yet another example, the calcium carbonate is present in an amount from about 27.0 wt. % to about 32.5 wt. %, based on the dry weight of the composition.

In one or more examples, the coating composition of the coating 230 includes titanium dioxide. The titanium dioxide may be present at any concentration needed to achieve the desired pigment-to-binder ratio as described herein. In one example, the titanium dioxide is present at a concentration from about 0.1 wt. % to about 10 wt. %, based upon the dry weight of the composition. In another example, the titanium dioxide is present at a concentration from about 0.5 wt. % to about 8 wt. %, based upon the dry weight of the composition. In yet another example, the titanium dioxide is present at a concentration or from about 1 wt. % to about 6 wt. %, based upon the dry weight of the composition. In a preferred example, the titanium dioxide is present at a concentration from about 5 wt. % to about 6 wt. %, based upon the dry weight of the composition.

In one or more examples, the coating composition the coating 230 includes calcined diatomaceous earth. The calcined diatomaceous earth may be present at any concentration needed to achieve the desired pigment-to-binder ratio as described herein. In one example, the calcined diatomaceous earth is present in an amount from about 1 wt. % to about 20 wt. %, based on the dry weight of the composition. In another example, the calcined diatomaceous earth is present in an amount from about 1 wt. % to about 10 wt. %, based on the dry weight of the composition. In yet another example, the calcined diatomaceous earth is present in an amount from about 1.5 wt. % to about 2 wt. %, based on the dry weight of the composition.

In one or more examples, the coating composition the coating 230 includes a flame-retardant filler. The flame retardant may include aluminum, such as aluminum hydroxide or aluminum trihydrate. The aluminum hydroxide may be present at any concentration needed to achieve the desired pigment-to-binder ratio as described herein. In one example, the aluminum hydroxide is present in an amount from about 3 wt. % to about 20 wt. %, based on the dry weight of the composition. In another example, the aluminum hydroxide is present in an amount from about 5 wt. % to about 20 wt. %, based on the dry weight of the composition. In yet another example, the aluminum hydroxide is present in an amount from about 17 wt. % to about 19 wt. %, based on the dry weight of the composition.

In one or more examples, the coating composition the coating 230 optionally includes a humectant. The humectant may include a hydrophobic polymer emulsion. In one example, the hydrophobic polymer emulsion is present in an amount from about 0.1 wt. % to about 10 wt. %, based on the dry weight of the composition. In another example, the hydrophobic polymer emulsion is present in an amount from about 0.2 wt. % to about 5.0 wt. %, based on the dry weight of the composition. In yet another example, the hydrophobic polymer emulsion is present in an amount from about 0.4 wt. % to about 0.5 wt. %, based on the dry weight of the composition.

The coating composition the coating 230 optionally includes a wetting and dispersing additive. In one example, the wetting and dispersing additive includes an anionic copolymer. The wetting and dispersing additive may have an acid value of about 2 mg KOH/g. In one example, the wetting and dispersing additive is present in an amount from about 0.1 wt. % to about 5 wt. %, based on the dry weight of the composition. In another example, the wetting and dispersing additive is present in an amount from about 0.1 wt. % to about 2 wt. %, based on the dry weight of the composition. In yet another example, the wetting and dispersing additive is present in an amount from about 0.1 wt. % to about 0.4 wt. %, based on the dry weight of the composition. In a further example, the wetting and dispersing additive is present in an amount from about 0.3 wt. % to about 0.4 wt. %, based on the dry weight of the composition.

The coating composition the coating 230 optionally includes a defoamer. The defoamer may include wax and/or mineral oil. In one example, the defoamer is present in an amount from about 0.01 wt. % to about 2 wt. %, based on the dry weight of the composition. In another example, the defoamer is present in an amount from about 0.01 wt. % to about 1 wt. %, based on the dry weight of the composition. In yet another example, the defoamer is present in an amount from about 0.1 wt. % to about 0.3 wt. %, based on the dry weight of the composition.

The coating composition optionally includes one or more biocides, such as an antimicrobial or antifungal additive. In one example, the one or more biocides are present in an amount from about 0.01 wt. % to about 1 wt. %, based on the dry weight of the composition. In another example, the one or more biocides are present in an amount from about 0.01 wt. % to about 0.5 wt. %, based on the dry weight of the composition. In yet another example, the one or more biocides are present in an amount from about 0.01 wt. % to about 0.0.05 wt. %, based on the dry weight of the composition.

The coating composition the coating 230 optionally includes a precipitated synthetic silicate additive. In one example, the precipitated synthetic silicate is present in an amount from 0.5 wt. % to about 5 wt. %, based on the dry weight of the composition. In another example, the precipitated synthetic silicate is present in an amount from about 0.5 wt. % to about 3.5 wt. %, based on the dry weight of the composition. In yet another example, the precipitated synthetic silicate is present in an amount from about 0.5 wt. % to about 2 wt. %, based on the dry weight of the composition. In yet another example, the precipitated synthetic silicate is present in an amount from about 0.8 wt. % to about 1 wt. %, based on the dry weight of the composition.

The coating composition the coating 230 optionally includes a calcined extender additive. In one example, the calcined extender is present in an amount from about 1 wt. % to about 6 wt. %, based on the dry weight of the composition. In another example, the calcined extender is present in an amount from about 2 wt. % to about 5 wt. %, based on the dry weight of the composition. In yet another example, the calcined extender is present in an amount from about 3 wt. % to about 4 wt. % %, based on the dry weight of the composition.

In one or more examples, the coating composition the coating 230 is characterized by a filler to binder ratio. The composition may have a filler to binder ratio ranging from about 0.1 to about 20. In another example, the composition has a filler to binder ratio ranging from about 1:1 to about 10:1. in another example, the composition has a filler to binder ratio ranging from about 1:1 to about 5:1. In a further example, the composition has a filler to binder ratio of about 1:1, about 2:1, about 3:1, or about 4:1.

The coating composition the coating 230 may be further characterized by its solids content. In one example, the coating composition has a solids content ranging from about 60 wt. % to about 75 wt. %.

As discussed above, the building panel 100 comprises substrate 120 and coating 230 over the side surface 123. The building panel 100 may also include a second coating 200 applied to the first major surface 121—as discussed further herein. The substrate 120 comprises first major surface 121 opposite a second major surface 122 and a side surface 123 that extends between the first major surface 121 and the second major surface 122, thereby defining a perimeter of the substrate 120. The substrate 120 may have a body thickness t₁ that extends from the first major surface 121 to the second major surface 122. The body thickness t₁ may range from about 5 mm to about 40 mm-including all values and sub-ranges there-between. The substrate 120 may be porous, thereby allowing airflow through the substrate 120 between the first major surface 121 and the second major surface 122. The substrate 120 may be comprised of a binder and fibers. In some examples, the substrate 120 may further comprise a filler and/or additive.

The building panel 100 may have an acoustic panel thickness to as measured from the first major exposed surface 111 to the second major exposed surface 112. The acoustic panel thickness to may range from about 5 mm to about 60 mm—including all values and sub-ranges there-between. The building panel 100 may have a length L_{P} ranging from about 5 cm to about 360 cm—including all values and sub-ranges there-the building panel 100 may have a width Wp ranging from about 10 cm to about 130 cm—including all values and sub-ranges there-between. The density of the building panel may vary. In certain examples, the density of the building panel is from about 0.02 g/cm³ to about 1.5 g/cm³. In certain examples, the building panel density is from about 0.03 g/cm³ to about 0.5 g/cm³. In further examples, the building panel density is from about 0.05 g/cm³ g/cm³ to about 0.2 g/cm³. In a further example, the building panel density is about 4 pcf, or 0.064 g/cm³. In yet a further example, the building panel density is about 10 pcf, or about 0.64 g/cm³.

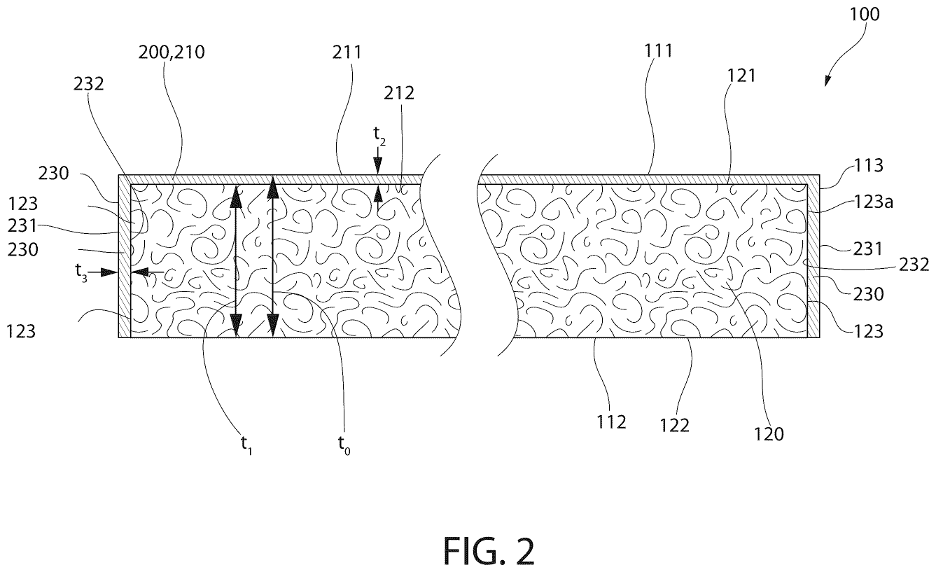

The coating 230 includes a first side 231 and a second side 232, see FIG. 2. The coating 230 has a thickness t₃ as measured between the first side 231 and the second side 232. The thickness t₃ ranges from 0.1 mm to about 3.0 mm.

Still referring to FIG. 2, a second coating 200 may be present on the first major surface 121 and side surface 123 of the substrate 120. In other examples, the second coating 200 may be only on the first major surface 121 or the second major surface 122. The side surface 123 includes a coating 230. The second coating 200 comprises a first side 211 opposite a second side 212. The second coating 200 may have a thickness t2 as measured from the first side 211 to the second side 212. One of skill in the art would recognize that a scrim 130 may be applied between the second coating 200 and the substrate 120 without deviating from the disclosure. Where a coating is present, the total thickness to of the building panel 100 includes the thickness of the second coating 200.

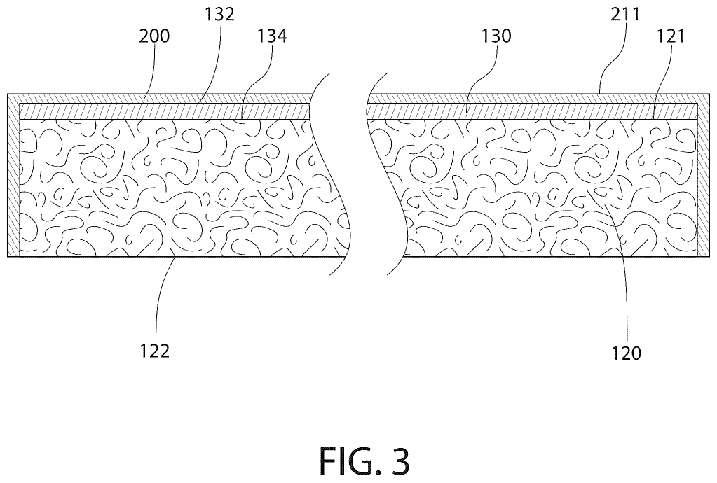

In one example, the building panel 100 includes a scrim 130 over the first major surface 121 of the substrate 120. In one example, the scrim 130 is a fiberglass scrim. In certain examples, the scrim 130 includes laminated non-woven glass fibers in a resin matrix. FIG. 3 illustrates an example where a scrim 130 is present on the upper surface 121 of the body 120 and the coating 200 is present on a first major scrim surface 132. The scrim 130 includes a first major scrim surface 132 opposite a second major scrim surface 134.

In one example, the building panel 100 includes a second coating 200 composition over the first major surface 121. In one example, the second coating composition includes a binder composition that is different than the coating composition of the coating 230 over the side surface 123. In one example, the second coating 200 includes a binder composition that is not crosslinkable.

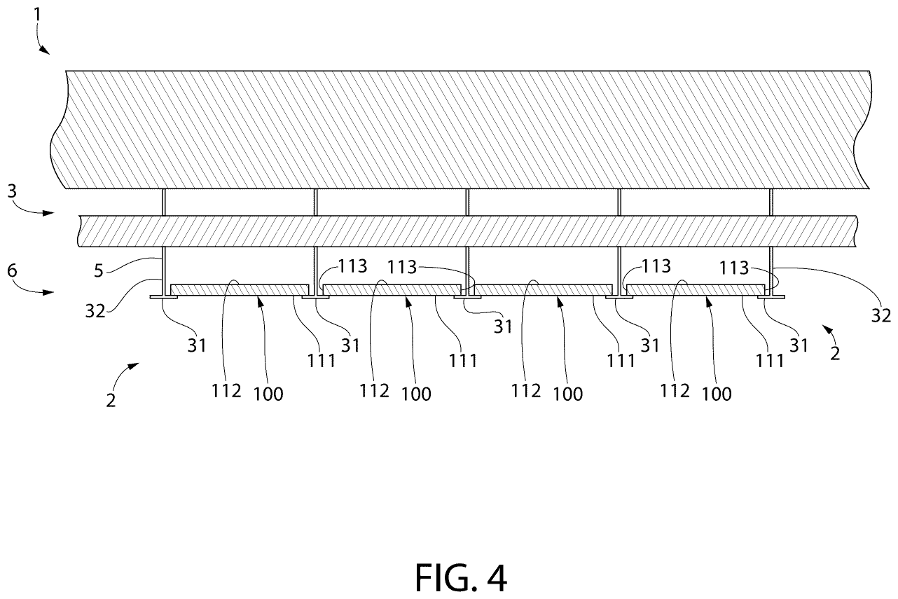

The present disclosure may further include a ceiling system. FIG. 4 shows an example of a ceiling system 1 comprising one or more of the building panels 100 installed in an interior space, whereby the interior space comprises a plenum space 3 and an active room environment 2. The building panels 100 may be joined together via a joint compound. Any all-purpose, commercially available joint compound material may be used without departing from the scope of the disclosure. The present disclosure is designed such that the coating 200 may be applied over both the building panels 100 and joint compound connecting the building panels 100 and offer desirable hiding power for both the acoustic panels 100, scrim 130 if present over the acoustic panels 100, and joint compound.

The plenum space 3 provides space for mechanical lines within a building (e.g., HVAC, plumbing, etc.). The active space 2 provides room for the building occupants during normal intended use of the building (e.g., in an office building, the active space would be occupied by offices containing computers, lamps, etc.). In the installed state, the building panels 100 may be supported in the interior space by one or more parallel support struts 5. Each of the support struts 5 may comprise an inverted T-bar having a horizontal flange 31 and a vertical web 32. The ceiling system 1 may further comprise a plurality of first struts that are substantially parallel to each other and a plurality of second struts that are substantially perpendicular to the first struts (not pictured). In some examples, the plurality of second struts intersects the plurality of first struts to create an intersecting ceiling support grid 6. The plenum space 3 exists above the ceiling support grid 6 and the active room environment 2 exists below the ceiling support grid 6.

In the installed state, the first major surface 111 of the building panel 100 may face the active room environment 2 and the second major surface 112 of the building panel 100 may face the plenum space 3. The building panel 100 may be installed according to at least two variations. In a first variation, the building panel 100 is positioned entirely above the horizontal flange 31 of the support struts 5. In the first variation, at least a portion of the first major surface may be concealed from the active room environment 2 by the horizontal flange 31 because the horizontal flange 31 contacts the first major surface 111, thereby supporting it in the ceiling system 1. In a first variation, the entire side surface 113—including the upper portion 113a and the lower portion 113b—may be concealed from the active room environment 2 by the horizontal flange 311. A second variation will be described further herein.

Also disclosed is a method manufacturing a building panel 100. In one or more examples, the method includes providing a substrate 120 having a first major surface 121 opposite a second major surface 122 and a side surface 123 extending there-between.

In one or more examples, the method includes applying a coating composition to form a coating 230 over the side surface 123. In another example, the method includes applying the coating composition over two or more of the first major surface 121, the second major surface 122, and the side surface 123. The coating 230 includes a coating composition having a binder that can self-crosslink or crosslink with additional crosslinking agents, a pigment composition, a flame retardant, and a filler composition.

In one example, the method includes applying a second coating composition over the first major surface 121 to form a second coating 200, wherein the second coating composition includes a binder composition that is different than the coating composition over the side surface. In one example, the second coating composition includes a binder composition that is not crosslinkable.

One of skill in the art would appreciate that the coating composition may also be used in other ceiling systems. Therefore, the examples described above are non-limiting examples.

### EXAMPLES

The examples and other implementations described herein are exemplary and not intended to be limiting in describing the full scope of compositions and methods of this disclosure. Equivalent changes, modifications and variations of specific implementations, materials, compositions, and methods may be made within the scope of the present disclosure, with substantially similar results.

While the present disclosure has been described with reference to several examples, which examples have been set forth in considerable detail for the purposes of making a complete disclosure of the disclosure, such examples are merely representative and are not intended to be limiting or represent an exhaustive enumeration of all aspects of the disclosure. The scope of the disclosure is to be determined from the claims appended hereto. Further, it will be apparent to those of skill in the art that numerous changes may be made in such details without departing from the spirit and the principles of the disclosure.

For the following Examples, several binders were tested in the coating compositions for compression strength, indent recovery, and durability.
Binder A: acrylic copolymer having a pH ranging from about 5.5 to about 6.5 and a glass transition temperature of −1° C.
Binder B: self-crosslinking vinyl acrylic copolymer having a pH ranging from about 4.0 to about 6.0, and a glass transition temperature of 25° C.
Binder C: Control binder comprising high molecular weight vinyl-acrylic latex, having a pH of 5 and glass transition temperature of 17° C.
Binder D: Control Binder comprising polyvinyl acetate homopolymer and having a pH of 7.0 and a glass transition temperature of 37° C.

TABLE 1

| | | % | | Dry | |
|---|---|---|---|---|---|
| | | Wet | % | Weight | Dry |
| | Amount | Weight | Solids | Amount | Weight |
| Component | (g) | (%) | (%) | (lbs) | % (%) |
| Binder A | 385.00 | 51.07% | 46.00% | 177.10 | 32.97% |
| Humectant | 3.92 | 0.52% | 65.00% | 2.55 | 0.47% |
| Defoamer | 2.77 | 0.37% | 25.00% | 0.69 | 0.13% |
| Dispersant | 3.50 | 0.46% | 35.00% | 1.23 | 0.23% |
| Wetting Agent | 2.23 | 0.30% | 35.00% | 0.78 | 0.15% |
| Titanium Dioxide | 28.00 | 3.71% | 100.00% | 28.00 | 5.21% |
| Silicate | 5.57 | 0.74% | 93.00% | 5.18 | 0.96% |
| Calcined | 25.20 | 3.34% | 100.00% | 25.20 | 4.69% |
| Extender | | | | | |
| Calcium | 179.20 | 23.77% | 99.80% | 178.84 | 33.30% |
| Carbonate | | | | | |
| Calcined | 9.19 | 1.22% | 100.00% | 9.19 | 1.71% |
| Diatomaceous | | | | | |
| Earth | | | | | |
| Aluminum | 100.26 | 13.30% | 99.60% | 99.85 | 18.59% |
| Hydroxide | | | | | |
| Filler | 8.40 | 1.11% | 99.50% | 8.36 | 1.56% |
| Biocide | 0.57 | 0.08% | 21.00% | 0.12 | 0.02% |
| Total= | 753.8 | 100.0% | | 537.09 | 100.00% |

Table 1 includes the formulation for Example 1. The binder in Example 1 includes an acrylic copolymer having a pH ranging from about 5.5 to about 6.5.

TABLE 2

| | | | | Dry | |
|---|---|---|---|---|---|
| | | % Wet | % | Weight | Dry |
| | Amount | Weight | Solids | Amount | Weight |
| Component | (g) | (%) | (%) | (g) | % (%) |
| Binder B | 322.00 | 46.61% | 55.00% | 177.10 | 32.97% |
| Humectant | 3.92 | 0.57% | 65.00% | 2.55 | 0.47% |
| Defoamer | 2.77 | 0.40% | 25.00% | 0.69 | 0.13% |
| Dispersant | 3.50 | 0.51% | 35.00% | 1.23 | 0.23% |
| Wetting Agent | 2.23 | 0.32% | 35.00% | 0.78 | 0.15% |
| Titanium | 28.00 | 4.05% | 100.00% | 28.00 | 5.21% |
| Dioxide | | | | | |
| Silicate | 5.57 | 0.81% | 93.00% | 5.18 | 0.96% |
| Calcined | 25.20 | 3.65% | 100.00% | 25.20 | 4.69% |
| Extender | | | | | |
| Calcium | 179.20 | 25.94% | 99.80% | 178.84 | 33.30% |
| Carbonate | | | | | |
| Calcined | 9.19 | 1.33% | 100.00% | 9.19 | 1.71% |
| Diatomaceous | | | | | |
| Earth | | | | | |
| Aluminum | 100.26 | 14.51% | 99.60% | 99.85 | 18.59% |
| Hydroxide | | | | | |
| Filler | 8.40 | 1.22% | 99.50% | 8.36 | 1.56% |
| Biocide | 0.57 | 0.08% | 21.00% | 0.12 | 0.02% |
| Thickener | 0.00 | 0.00% | 28.00% | 0.00 | 0.00% |
| Total= | 690.8 | 100.0% | | 537.09 | 100.00% |

Table 2 includes the formulation for Example 2. The binder in Example 2 includes vinyl acrylic copolymer binder having a pH ranging from about 4.0 to about 6.0.

TABLE 3

| | | | | Dry | |
|---|---|---|---|---|---|
| | | % Wet | % | Weight | Dry |
| | Amount | Weight | Solids | Amount | Weight |
| Component | (g) | (%) | (%) | (g) | % (%) |
| Binder C | 322.00 | 46.61% | 55.00% | 177.10 | 32.97% |
| Humectant | 3.92 | 0.57% | 65.00% | 2.55 | 0.47% |
| Defoamer | 2.77 | 0.40% | 25.00% | 0.69 | 0.13% |
| Dispersant | 3.50 | 0.51% | 35.00% | 1.23 | 0.23% |
| Wetting | 2.23 | 0.32% | 35.00% | 0.78 | 0.15% |
| Agent | | | | | |
| Titanium | 28.00 | 4.05% | 100.00% | 28.00 | 5.21% |
| Dioxide | | | | | |
| Silicate | 5.57 | 0.81% | 93.00% | 5.18 | 0.96% |
| Calcined | 25.20 | 3.65% | 100.00% | 25.20 | 4.69% |
| Extender | | | | | |
| Calcium | 179.20 | 25.94% | 99.80% | 178.84 | 33.30% |
| Carbonate | | | | | |
| Calcined | 9.19 | 1.33% | 100.00% | 9.19 | 1.71% |
| Diatomaceous | | | | | |
| Earth | | | | | |
| Aluminum | 100.26 | 14.51% | 99.60% | 99.85 | 18.59% |
| Hydroxide | | | | | |
| Filler | 8.40 | 1.22% | 99.50% | 8.36 | 1.56% |
| Biocide | 0.57 | 0.08% | 21.00% | 0.12 | 0.02% |
| Total= | 690.8 | 100.0% | | 537.09 | 100.00% |

Table 3 includes the formulation for Control 1. The binder in Control 1 includes vinyl acrylic copolymer having a pH of about 5.0.

TABLE 4

| | | | | Dry | |
|---|---|---|---|---|---|
| | | % Wet | % | Weight | Dry |
| | Amount | Weight | Solids | Amount | Weight % |
| Component | (g) | (%) | (%) | (g) | (%) |
| Binder D | 365.75 | 48.90% | 50.00% | 182.88 | 32.97% |
| Humectant | 5.66 | 0.76% | 65.00% | 3.68 | 0.66% |
| Defoamer | 2.83 | 0.38% | 25.00% | 0.71 | 0.13% |
| Dispersant | 4.71 | 0.63% | 35.00% | 1.65 | 0.30% |
| Wetting Agent | 2.27 | 0.30% | 35.00% | 0.80 | 0.14% |
| Titanium | 19.89 | 2.66% | 100.00% | 19.89 | 3.59% |
| Dioxide | | | | | |
| Silicate | 5.68 | 0.76% | 93.00% | 5.29 | 0.95% |
| Calcined | 34.67 | 4.64% | 100.00% | 34.67 | 6.25% |
| Extender | | | | | |
| Calcium | 159.14 | 21.28% | 99.80% | 158.82 | 28.63% |
| Carbonate | | | | | |
| Calcined | 9.38 | 1.25% | 100.00% | 9.38 | 1.69% |
| Diatomaceous | | | | | |
| Earth | | | | | |
| Aluminum | 102.30 | 13.68% | 99.60% | 101.89 | 18.37% |
| Hydroxide | | | | | |
| Filler | 23.11 | 3.09% | 99.50% | 22.99 | 4.15% |
| Clay | 9.68 | 1.29% | 100.00% | 9.68 | 1.74% |
| Magnesium | 2.27 | 0.30% | 100.00% | 2.27 | 0.41% |
| Aluminosilicate | | | | | |
| Biocide | 0.58 | 0.08% | 21.00% | 0.12 | 0.02% |
| Thickener | 0.00 | 0.00% | 28.00% | 0.00 | 0.00% |
| Total= | 747.9 | 100.0% | | 554.71 | 100.00% |

Table 4 includes the formulation for Control 2. The binder in Control 2 includes carboxylated polyvinyl acetate homopolymer having a pH of about 7.0.

TABLE 5

| | | % Wet | % | Dry | Dry |
|---|---|---|---|---|---|
| | Amount | Weight | Solids | Weight | Weight |
| Component | (g) | (%) | (%) | Amount (g) | % (%) |
| Binder A | 511.07 | 51.11% | 46% | 235.09 | 33.08% |
| Defoamer | 3.68 | 0.37% | 25% | 0.92 | 0.13% |
| Dispersant | 4.65 | 0.46% | 35% | 1.63 | 0.23% |
| Wetting Agent | 2.96 | 0.30% | 35% | 1.04 | 0.15% |
| Titanium | 37.17 | 3.72% | 100% | 37.17 | 5.23% |
| Dioxide | | | | | |
| Silicate | 7.39 | 0.74% | 93% | 6.88 | 0.97% |
| Calcined | 33.45 | 3.35% | 100% | 33.45 | 4.71% |
| Extender | | | | | |
| Calcium | 237.88 | 23.79% | 100% | 237.41 | 33.40% |
| Carbonate | | | | | |
| Calcined | 12.20 | 1.22% | 100% | 12.20 | 1.72% |
| Diatomaceous | | | | | |
| Earth | | | | | |
| Aluminum | 133.09 | 13.31% | 100% | 132.55 | 18.65% |
| Hydroxide | | | | | |
| Mica | 11.15 | 1.12% | 100% | 11.09 | 1.56% |
| Defoamer | 3.68 | 0.37% | 25% | 0.92 | 0.13% |
| Biocide | 0.75 | 0.08% | 21% | 0.16 | 0.02% |
| Thickener | 0.88 | 0.09% | 28% | 0.25 | 0.03% |
| Total= | 1000.00 | 100% | | 710.75 | 100% |

Table 5 includes the formulation for Example 3. The binder in Example 3 includes an acrylic copolymer having a pH ranging from about 5.5 to about 6.5.

TABLE 6

| | | | | Compression | |
|---|---|---|---|---|---|
| | | | | Strength | Visual |
| Binder | Solids | Formula | F/B | (lbf/sq in) | Observations |
| Binder A | 69.97% | Example 1 | 2 | 23.9 | no crack, good |
| | | | | | indent recovery |
| Binder B | 73.70% | Example 2 | 2 | 72.7 | damage |
| Binder C | 69.40% | Control 1 | 2 | 33.9 | crack and damage |
| Binder D | 70.5% | Control 2 | 2 | 87.8 | crack and damage |
| Binder A | 69.81% | Example 3 | 2 | 29.7 | No crack, good |
| | | | | | indent recovery |

As shown in Table 6, the Examples and Controls were tested for compression strength and resilience. It was found that using the composition of Example 1 and 3 with a binder having a glass transition temperature below 1° C. exhibited superior compression strength and resilience properties. Further, upon visual inspection, no cracks or indent damage were observed using a coating application rate at 96 grams per square foot and a filler to binder ratio of 2:1.

### EXEMPLARY CLAIMS

The disclosure may be further characterized by the following Exemplary Claims
Exemplary claim 1. A coating composition comprising: a crosslinkable binder composition comprising a binding agent; a pigment composition; a flame retardant filler; a filler composition; and a biocide.
Exemplary claim 2. The coating composition according to Exemplary claim 1, wherein the binder composition comprises an acrylic copolymer.
Exemplary claim 3. The coating composition according to Exemplary claim 1 or Exemplary claim 2, wherein the binder composition comprises vinyl-acrylic latex.
Exemplary claim 4. The coating composition according to any one of Exemplary claims 1 to 3, wherein the binder composition comprises a pH ranging from about 5.5 to about 6.5.
Exemplary claim 5. The coating composition according to any one of Exemplary claims 1 to 4, wherein the binder composition has a glass transition temperature below ambient temperature.
Exemplary claim 6. The coating composition according to any one of Exemplary claims 1 to 5, wherein the binder composition has a glass transition temperature below 10° C.
Exemplary claim 7. The coating composition according to any one of Exemplary claims 1 to 5, wherein the binder composition comprises a glass transition temperature below 1° C.
Exemplary claim 8. The coating composition according to any one of Exemplary claims 1 to 7, wherein the binder composition comprises a viscosity less than 500 cps.
Exemplary claim 9. The coating composition according to any one of Exemplary claims 1 to 8 having a solids content ranging from about 60 wt. % to about 75 wt. %.
Exemplary claim 10. The coating composition according to any one of Exemplary claims 1 to 9, wherein the binder composition comprises a blend of a first binder and a second binder.
Exemplary claim 11. The coating composition according to Exemplary claim 10, wherein the first binder has a first glass transition temperature, and the second binder has a second glass transition temperature that is different than the first glass transition temperature.
Exemplary claim 12. The coating composition according to any one of Exemplary claims 1 to 11 comprising a filler to binder ratio ranging from about 0.1 to about 20.
Exemplary claim 13. The coating composition according to any one of Exemplary claims 1 to 11 comprising a filler to binder ratio ranging from about 1:1 to about 4:1.
Exemplary claim 14. The coating composition according to any one of Exemplary claims 1 to 11 comprising a filler to binder ratio of about 2:1.
Exemplary claim 15. The coating composition according to any one of Exemplary claims 1 to 14, wherein the pigment composition comprises titanium dioxide.
Exemplary claim 16. The coating composition according to any one of Exemplary claims 1 to 15, further comprising a humectant comprising a hydrophobic polymer emulsion.
Exemplary claim 17. The coating composition according to Exemplary claim 16, wherein the humectant comprises a pH ranging from about 7 to about 9.
Exemplary claim 18. The coating composition according to any one of Exemplary claims 1 to 17, further comprising clay.
Exemplary claim 19. The coating composition according to any one of Exemplary claims 1 to 18, further comprising a calcined extender.
Exemplary claim 20. The coating composition according to any one of Exemplary claims 1 to 19, further comprising a dispersant.
Exemplary claim 21. The coating composition according to any one of Exemplary claims 1 to 20, further comprising a wetting agent.
Exemplary claim 22. The coating composition according to any one of Exemplary claims 1 to 21, further comprising a defoamer.
Exemplary claim 23. The coating composition according to any one of Exemplary claims 1 to 22, wherein the biocide comprises one or more antimicrobial agents.
Exemplary claim 24. A building panel comprising: a substrate having a first major surface opposite a second major surface and a side surface extending there-between; and a coating composition over at least one of the first major surface, the second major surface, and the side surface, the coating composition comprising: a crosslinkable binder comprising one or more hydroxy, carboxy, amine, glycidyl, N-methylol, isocyanate, carbodiimide or aziridine; a pigment composition; a flame retardant; and a filler composition.
Exemplary claim 25. The building panel according to Exemplary claim 24, wherein the coating composition is present in an amount ranging from about 30 g/sqft to 200 g/sqft.
Exemplary claim 26. The building panel according to Exemplary claim 24 or 25, wherein the coating composition further comprises a humectant.
Exemplary claim 27. The building panel according to any one of Exemplary claims 24 to 26, wherein the coating composition further comprises a biocide.
Exemplary claim 28. The building panel according to any one of Exemplary claims 24 to 27, wherein the binder composition comprises an acrylic copolymer.
Exemplary claim 29. The building panel according to any one of Exemplary claims 24 to 28, wherein the binder composition comprises vinyl-acrylic latex.
Exemplary claim 30. The building panel according to any one of Exemplary claims 24 to 29, wherein the binder composition comprises a pH ranging from about 5.5 to about 6.5.
Exemplary claim 31. The building panel according to any one of Exemplary claims 24 to 30, wherein the binder composition has a glass transition temperature below ambient temperature.
Exemplary claim 32. The building panel according to any one of Exemplary claims 24 to 30, wherein the binder composition has a glass transition temperature below 10° C.
Exemplary claim 33. The building panel according to any one of Exemplary claims 24 to 30, wherein the binder composition comprises a glass transition temperature below 1° C.
Exemplary claim 34. The building panel according to any one of Exemplary claims 24 to 33, further comprising a scrim over the first major surface.
Exemplary claim 35. The building panel according to Exemplary claim 34, wherein the scrim is a fiberglass scrim.
Exemplary claim 36. The building panel according to any one of Exemplary claims 24 to 35, further comprising a second coating composition over one of the first major surface and the second major surface, wherein the second coating composition comprises a binder composition that is different than the coating composition over the side surface.
Exemplary claim 37. The building panel according to Exemplary claim 36, wherein the second coating composition comprises a binder composition that is not crosslinkable.
Exemplary claim 38. A ceiling panel comprised of the building panel according to any one of Exemplary claims 24 to 37.
Exemplary claim 39. A wall panel comprised of the building panel according to any one of Exemplary claims 24 to 37.
Exemplary claim 40. A surface covering system comprising: a plurality of building panels configured to be positioned adjacent each other, each building panel of the plurality of building panels comprising: a substrate having a first major surface opposite a second major surface and a side surface extending there-between; and a coating composition over at least one of the first major surface, the second major surface, and the side surface, the coating composition comprising: a crosslinkable binder comprising one or more hydroxy, carboxy, amine, glycidyl, N-methylol, isocyanate, carbodiimide or aziridine; a pigment composition; a flame retardant; and a filler composition.
Exemplary claim 41. The surface covering system according to Exemplary claim 40, wherein the coating composition is present in an amount ranging from about 30 g/sqft to 200 g/sqft.
Exemplary claim 42. The surface covering system according to Exemplary claim 40 or 41, wherein the coating composition further comprises a humectant.
Exemplary claim 43. The surface covering system according to any one of Exemplary claims 40 to 42, wherein the coating composition further comprises a biocide.
Exemplary claim 44. The surface covering system according to any one of Exemplary claims 40 to 43, wherein the binder composition comprises an acrylic copolymer.
Exemplary claim 45. The surface covering system according to any one of Exemplary claims 40 to 44, wherein the binder composition comprises vinyl-acrylic latex.
Exemplary claim 46. The surface covering system according to any one of Exemplary claims 40 to 45, wherein the binder composition comprises a pH ranging from about 5.5 to about 6.5.
Exemplary claim 47. The surface covering system according to any one of Exemplary claims 40 to 46, wherein the binder composition has a glass transition temperature below ambient temperature.
Exemplary claim 48. The surface covering system according to any one of Exemplary claims 40 to 47, wherein the binder composition comprises a glass transition temperature below 1° C.
Exemplary claim 49. The surface covering system according to any one of Exemplary claims 40 to 48, wherein the plurality of building panels defines a ceiling.
Exemplary claim 50. The surface covering system according to any one of Exemplary claims 40 to 48, wherein the plurality of building panels defines a wall.
Exemplary claim 51. A method for manufacturing a building panel comprising: providing a substrate having a first major surface opposite a second major surface and a side surface extending there-between; applying a coating composition over at least one of the first major surface, the second major surface, and the side surface, the coating composition comprising: a crosslinkable binder comprising one or more hydroxy, carboxy, amine, glycidyl, N-methylol, isocyanate, carbodiimide or aziridine; a pigment composition; a flame retardant; and a filler composition.
Exemplary claim 52. The method according to Exemplary claim 51, further comprising applying a second coating composition over the first major surface, wherein the second coating composition comprises a binder composition that is different than the coating composition over the side surface.
Exemplary claim 53. The method according to Exemplary claim 52, wherein the second coating composition comprises a binder composition that is not crosslinkable.

What is claimed is:

1. A coating composition comprising:
a crosslinkable binder composition comprising a binding agent;
a pigment composition;
a flame retardant filler;
a filler composition; and
a biocide.

2. The coating composition according to claim 1, wherein the binder composition comprises an acrylic copolymer.

3. The coating composition according to claim 1, wherein the binder composition comprises vinyl-acrylic latex.

4. The coating composition according to claim 1, wherein the binder composition comprises a pH ranging from about 5.5 to about 6.5.

5. The coating composition according to claim 1, wherein the binder composition has a glass transition temperature below 1° C.

6. The coating composition according to claim 1, wherein the binder composition comprises a blend of a first binder and a second binder, wherein the first binder has a first glass transition temperature, and the second binder has a second glass transition temperature that is different than the first glass transition temperature.

7. The coating composition according to claim 1 comprising a filler to binder ratio ranging from about 0.1 to about 20.

8. The coating composition according to claim 1 comprising a filler to binder ratio ranging from about 1:1 to about 4:1.

9. The coating composition according to claim 1, further comprising a humectant comprising a hydrophobic polymer emulsion.

10. A building panel comprising:
a substrate having a first major surface opposite a second major surface and a side surface extending there-between; and
a coating composition over at least one of the first major surface, the second major surface, and the side surface, the coating composition comprising:
a crosslinkable binder comprising one or more hydroxy, carboxy, amine, glycidyl, N-methylol, isocyanate, carbodiimide or aziridine;
a pigment composition;
a flame retardant; and
a filler composition.

11. The building panel according to claim 10, wherein the coating composition is present in an amount ranging from about 30 g/sqft to 200 g/sqft.

12. The building panel according to claim 10, wherein the binder composition comprises a pH ranging from about 5.5 to about 6.5.

13. The building panel according to claim 10, wherein the binder composition comprises a glass transition temperature below 1° C.

14. The building panel according to claim 10, further comprising a second coating composition over one of the first major surface and the second major surface, wherein the second coating composition comprises a binder composition that is different than the coating composition over the side surface.

15. A surface covering system comprising:
a plurality of building panels configured to be positioned adjacent each other, each building panel of the plurality of building panels comprising:
a substrate having a first major surface opposite a second major surface and a side surface extending there-between; and
a coating composition over at least one of the first major surface, the second major surface, and the side surface, the coating composition comprising:
a crosslinkable binder comprising one or more hydroxy, carboxy, amine, glycidyl, N-methylol, isocyanate, carbodiimide or aziridine;
a pigment composition;
a flame retardant; and
a filler composition.

16. The surface covering system according to claim 15, wherein the coating composition is present in an amount ranging from about 30 g/sqft to 200 g/sqft.

17. The surface covering system according to claim 15, wherein the coating composition further comprises a biocide.

18. The surface covering system according to claim 15, wherein the binder composition comprises vinyl-acrylic latex.

19. The surface covering system according to claim 15, wherein the binder composition comprises a pH ranging from about 5.5 to about 6.5.

20. The surface covering system according to claim 15, wherein the binder composition comprises a glass transition temperature below 1° C.
